(19) United States
(12) Patent Application Publication
(10) Pub. No.: US 2014/0090933 A1
(43) Pub. Date: Apr. 3, 2014

(54) DISC BRAKE

(71) Applicant: Hitachi Automotive Systems, Ltd., Ibaraki (JP)

(72) Inventors: Takayasu SAKASHITA, Tokyo (JP); Jun WATANABE, Kanagawa (JP); Satoru TSURUMI, Yamanashi (JP); Takaaki FUSE, Yamanashi (JP)

(73) Assignee: Hitachi Automotive Systems, Ltd., Ibaraki (JP)

(21) Appl. No.: 14/033,587

(22) Filed: Sep. 23, 2013

(30) Foreign Application Priority Data
Sep. 28, 2012 (JP) 216273/2012

(51) Int. Cl. F16D 55/226

(52) U.S. Cl. CPC F16D 55/226
USPC 188/72.4

(57) ABSTRACT

Provided is a disc brake with high reliability. In a disc brake (1), pins (60) press-fitted to a carrier (58) are inserted through hole portions (56B) of respective planet gears (56) in a freely rotatable and axially movable manner. Further, axial movement of the carrier (58) is allowed by an amount corresponding to a length of a clearance (37). As a result, when a rotary-to-linear ramp (65) advances during actuation of a parking brake, the carrier (58) and the pins (60) advance together with the rotary-to-linear ramp (65). Thus, actuation efficiency becomes excellent and durability is enhanced.

### BACKGROUND OF THE INVENTION

1. Technical Field

The present invention relates to a disc brake to be used for applying a brake to a vehicle.

2. Background Art

For example, Japanese Patent Application Laid-open No. 2011-179569 discloses a disc brake configured to move a piston through a drive force of an electric motor. In this disc brake, a rotational drive generated by the electric motor is transmitted through an intermediation of a pinion of a first speed reduction gear to a second speed reduction gear. In this case, the second speed reduction gear and a drive shaft integrally provided to a rotary-to-linear plate are coupled to each other so as to be relatively immovable in rotational and axial directions thereof. When the rotary-to-linear plate moves linearly, the second speed reduction gear moves in the axial direction together with the rotary-to-linear plate.

However, as in the disc brake of the invention disclosed in Japanese Patent Application Laid-open No. 2011-179569, when the portion for transmitting the rotation moves in the axial direction, wear of a meshing portion thereof is progressed. This causes a fear of decrease in durability of the portion for transmitting the rotation, resulting in a problem in that the reliability of the disc brake is difficult to secure.

### SUMMARY OF INVENTION

In view of the above, the present invention has an object to secure the reliability of a disc brake.

As means for solving the problem described above, according to one embodiment of the present invention, there is provided a disc brake, including: a pair of pads arranged across a rotor at positions on both sides in an axial direction of the rotor; a piston for pressing one of the pair of pads; a caliper body including a cylinder having the piston received therein in a movable manner; an electric motor provided to the caliper body; a speed reduction mechanism for increasing and transmitting a rotational force of the electric motor by a plurality of rotational members; and a piston propelling mechanism linearly movable due to the rotational force transmitted from the speed reduction mechanism so as to propel the piston to a braking position, in which the piston propelling mechanism includes a portion coupled to the speed reduction mechanism, which is linearly movable in an axial direction of the cylinder relative to a portion of the speed reduction mechanism that receives the rotational force input from the electric motor, in which the speed reduction mechanism includes a shaft member for axially supporting at least one of a plurality of gears meshing with each other, and in which one of the shaft member and a bearing portion for supporting the shaft member is provided so as to be freely rotatable and axially movable relative to the at least one of the plurality of gears, and is provided integrally with the portion coupled to the speed reduction mechanism.

Further, according to one embodiment of the present invention, there is provided a disc brake, including: a piston for pressing a pad against a disc rotor; a caliper body including a cylinder having the piston received therein in a movable manner; an electric motor provided to the caliper body; a speed reduction mechanism for increasing and transmitting a rotational force of the electric motor by a plurality of rotational members; and a piston propelling mechanism linearly movable due to the rotational force transmitted from the speed reduction mechanism so as to propel the piston to a braking position, in which the piston propelling mechanism includes a portion coupled to the speed reduction mechanism, which is linearly movable in an axial direction of the cylinder relative to a portion of the speed reduction mechanism that receives the rotational force input from the electric motor, in which the speed reduction mechanism includes a shaft member for axially supporting at least one of a plurality of gears meshing with each other, and in which the shaft member is provided so as to be freely rotatable and axially movable relative to the at least one of the plurality of gears, and is provided so as to be linearly movable together with the portion coupled to the speed reduction mechanism.

Further, according to one embodiment of the present invention, there is provided a disc brake, including: a caliper body having a cylinder into which a piston is received in a movable manner, the piston being configured to press a pad against a disc rotor; a speed reduction mechanism for increasing and transmitting a rotational force of an electric motor by a plurality of rotational members, the electric motor being provided to the caliper body; and a piston propelling mechanism linearly movable due to the rotational force transmitted from the speed reduction mechanism so as to propel the piston to a braking position, in which the piston propelling mechanism includes a portion coupled to the speed reduction mechanism, which is linearly movable in an axial direction of the cylinder relative to a portion of the speed reduction mechanism that receives the rotational force input from the electric motor, in which the speed reduction mechanism includes: a sun gear serving as a portion for transmitting the rotational force from the electric motor; a plurality of planet gears meshing with the sun gear; an internal gear meshing with each of the plurality of planet gears; and a carrier for axially supporting the each of the plurality of planet gears, the carrier including a portion coupled to the piston propelling mechanism, and in which the carrier further includes a shaft member for axially supporting the each of the plurality of planet gears in a freely rotatable and axially movable manner.

With the disc brake according to one embodiment of the present invention, the reliability of the disc brake may be secured.

### BRIEF DESCRIPTION OF DRAWINGS

In the accompanying drawings:

FIG. 1 is a sectional view illustrating a disc brake according to an embodiment of the present invention;

FIG. 2 is a partially enlarged sectional view illustrating the disc brake of FIG. 1;

FIG. 3 is a partially enlarged sectional view illustrating the disc brake of FIG. 1;

FIG. 4 is an exploded perspective view illustrating components inside a housing of FIG. 1;

FIGS. 5A and 5B are explanatory views illustrating actions of the disc brake according to the embodiment of the present invention; and

FIGS. 6A and 6B are explanatory views illustrating actions of a disc brake according to a modification example of the embodiment of the present invention.

### DESCRIPTION OF EMBODIMENTS

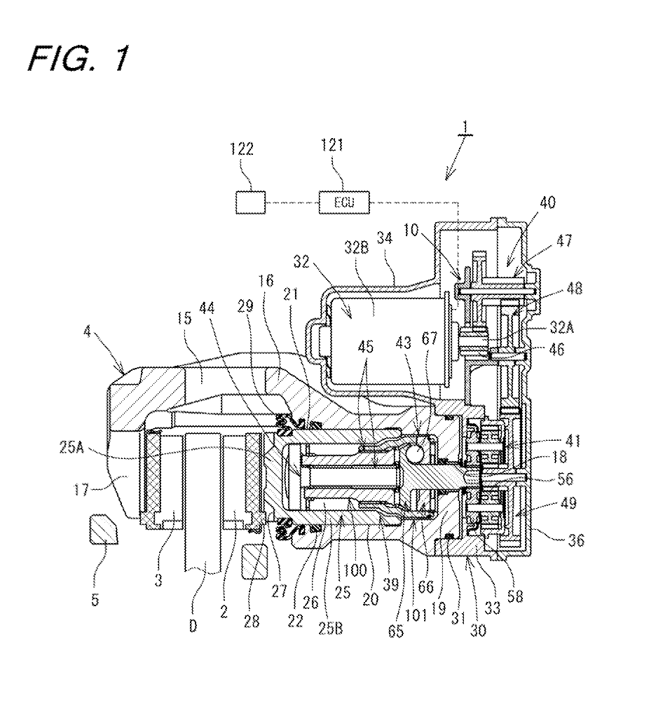

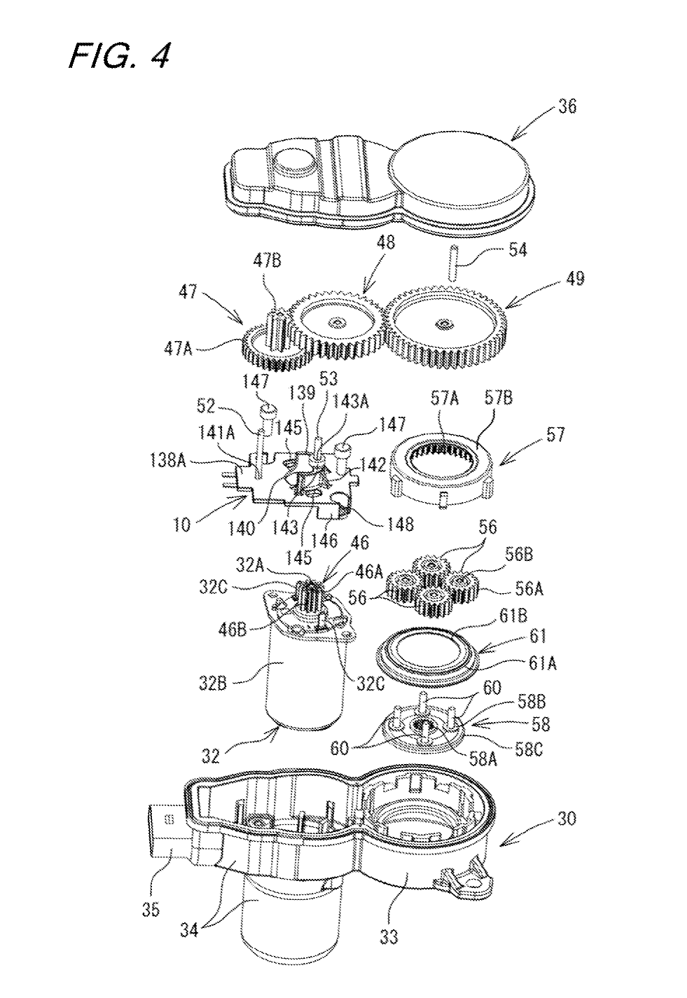

Now, an embodiment of the present invention is described in detail with reference to FIGS. 1 to 6. As illustrated in FIG. 1, a disc brake 1 according to this embodiment includes a pair of an inner brake pad 2 and an outer brake pad 3 arranged on both sides in an axial direction across a disc rotor D mounted on a rotary unit of a vehicle, and also includes a caliper 4. The disc brake 1 of this embodiment is a floating caliper disc brake. Note that, the pair of the inner brake pad 2 and the outer brake pad 3, and the caliper 4 are supported by a bracket 5, which is fixed to a stationary unit (not shown) such as a knuckle of the vehicle, so as to be movable in the axial direction of the disc rotor D.

A caliper body 15 as a main component of the caliper 4 includes a cylinder portion 16 arranged on a proximal end side to be opposed to the inner brake pad 2 on an inner side of the vehicle, and a claw portion 17 arranged on a distal end side to be opposed to the outer brake pad 3 on an outer side of the vehicle. The cylinder portion 16 includes a bottomed cylinder 20 formed therein, which has an opening portion 21 on the inner brake pad 2 side and is closed on the opposite side by a bottom wall 19 having a hole portion 18. The cylinder 20 includes a piston seal 22 provided in its inner peripheral surface on the opening portion 21 side.

A piston 25 is formed into a shape of a bottomed cup having a bottom portion 25A and a cylindrical portion 25B. The piston 25 is received in the cylinder 20 so that the bottom portion 25A of the piston 25 is opposed to the inner brake pad 2. The piston 25 is movable in the axial direction under a state in which the piston 25 is held in contact with the piston seal 22. A hydraulic chamber 26 defined by the piston seal 22 is formed between the piston 25 and the bottom wall 19 of the cylinder 20. The hydraulic chamber 26 is supplied with a hydraulic pressure from a hydraulic pressure source (not shown) such as a master cylinder and a hydraulic pressure control unit through a port (not shown) provided in the cylinder portion 16. The piston 25 has a depression 27 formed on an outer peripheral side of a bottom surface that is opposed to the inner brake pad 2. The depression 27 engages with a projection 28 formed on a back surface of the inner brake pad 2. Due to the engagement, the piston 25 is non-rotatable relative to the cylinder 20 and therefore the caliper body 15. Further, a dust boot 29 is interposed between the bottom portion 25A of the piston 25 and the cylinder 20 so as to prevent foreign matter from entering the cylinder 20.

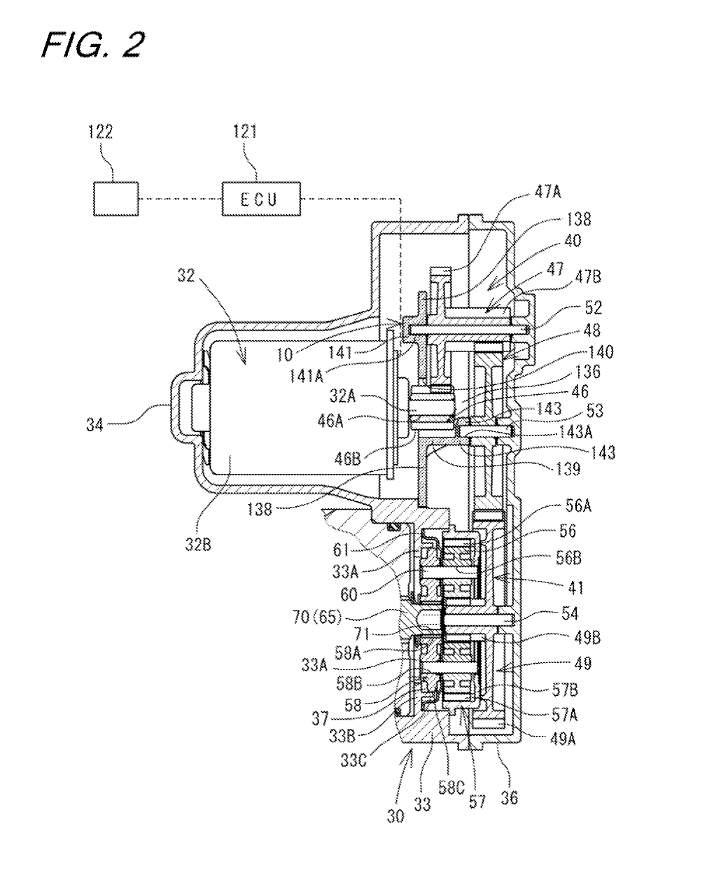

As illustrated in FIGS. 1 and 2, a housing 30 is mounted in an airtight manner on the bottom wall 19 side of the cylinder 20 of the caliper body 15. The airtightness between the housing 30 and the bottom wall 19 of the cylinder 20 is maintained by a seal member 31. The housing 30 is formed so as to receive a motor 32 as an example of an electric motor that is juxtaposed to the caliper body 15. That is, the housing 30 includes a first housing 33, which is formed so as to cover an outer periphery of the bottom wall 19 of the cylinder 20 and is configured to receive a planetary gear speed reduction mechanism 41 described later and the like, and a second housing 34, which is formed integrally with the first housing 33 in a juxtaposed manner and is configured to receive the motor 32.

The first housing 33 includes an opening portion 33A for inserting therethrough a columnar portion 70 of a rotary-to-linear ramp 65 of a ball-and-ramp mechanism 43, a wall portion 33B formed around the opening portion 33A, and a cylindrical wall portion 33C projecting from the wall portion 33B toward a cover 36. The cover 36 is mounted in an airtight manner on an opening formed at one end of the first housing 33 and the second housing 34 of the housing 30. The airtightness between the first housing 33 and the cover 36 and between the second housing 34 and the cover 36 is maintained by welding or bonding. Note that, in order to maintain the airtightness, the housing 30 and the cover 36 may be joined to each other by interposing a seal member, which is formed of an elastic body such as rubber, between the housing 30 and the cover 36.

As illustrated in FIG. 1, the caliper body 15 includes a piston propelling mechanism 39 for moving the piston 25 through drive of the motor 32, and a spur gear multistage speed reduction mechanism 40 and the planetary gear speed reduction mechanism 41 each serving as a speed reduction mechanism for increasing a rotational force of the motor 32. The spur gear multistage speed reduction mechanism 40 and the planetary gear speed reduction mechanism 41 are received in the first housing 33 and the second housing 34. The piston propelling mechanism 39 also has a thrust retaining function for retaining the piston 25 at a braking position. Note that, the structure of the speed reduction mechanism is not limited to the embodiment of the present invention, and only needs to transmit the drive force of the motor 32 to the piston propelling mechanism 39.

The piston propelling mechanism 39 includes the ball-and-ramp mechanism 43 for converting a rotary motion from the spur gear multistage speed reduction mechanism 40 and the planetary gear speed reduction mechanism 41 into a motion in a linear direction (hereinafter referred to as “linear motion” for convenience) to apply a thrust force to the piston 25, a push rod 44 for pressing the piston 25 through an action of the ball-and-ramp mechanism 43, and a screw mechanism 45 arranged between the push rod 44 and the bottom wall 19 of the cylinder 20 and serving as a thrust retaining mechanism for retaining the piston 25 at the braking position. The ball-and-ramp mechanism 43, the push rod 44, and the screw mechanism 45 are received in the cylinder 20 of the caliper body 15.

Note that, in the present invention, the ball-and-ramp mechanism is used as the mechanism for converting the rotary motion into the linear motion, but the present invention is not limited thereto, and is applicable to any mechanism that converts the rotary motion into the linear motion and causes the input shaft to linearly move along with the rotation.

As illustrated in FIGS. 1, 2, and 4, the spur gear multistage speed reduction mechanism 40 includes a pinion gear 46, a first speed reduction gear 47, a non-speed reduction spur gear 48, and a second speed reduction gear 49. The pinion gear 46 is formed into a tubular shape, and includes a hole portion 46A press-fitted onto a rotation shaft 32A of the motor 32, and a gear 46B formed on an outer periphery of the hole portion 46A.

The first speed reduction gear 47 integrally includes a wheel 47A, which is large in diameter and meshes with the gear 46B of the pinion gear 46, and a pinion 47B, which is small in diameter and formed to extend in the axial direction from the wheel 47A. The first speed reduction gear 47 is rotatably supported by a shaft 52 that is supported at one end by a bearing member 10 and at another end by the cover 36.

Further, the pinion 47B of the first speed reduction gear 47 meshes with the non-speed reduction spur gear 48. The non-speed reduction spur gear 48 is rotatably supported by a shaft 53 that is supported at one end by the bearing member 10 and at another end by the cover 36. The second speed reduction gear 49 integrally includes a wheel 49A, which is large in diameter and meshes with the non-speed reduction spur gear 48, and a sun gear 49B, which is small in diameter and formed to extend in the axial direction from the wheel 49A. The sun gear 49B is constructed as a part of the planetary gear speed reduction mechanism 41 described later. The second speed reduction gear 49 is rotatably supported by a shaft 54 that is supported by the cover 36.

The planetary gear speed reduction mechanism 41 includes the sun gear 49B of the second speed reduction gear 49, a plurality of (in this embodiment, four) planet gears 56, an internal gear 57, and a carrier 58. Each of the planet gears 56 includes a gear 56A, which meshes with the sun gear 49B of the second speed reduction gear 49, and a hole portion 56B for inserting therethrough a pin 60 as a shaft member, which is provided upright from the carrier 58, in a freely rotatable and axially movable manner. The planet gears 56 are arranged equiangularly on a circumference of the carrier 58.

The carrier 58 is formed into a disc shape, and includes a spline hole 58A provided at a substantially radial center thereof, and an annular flange portion 58C projecting outward from an outer peripheral surface of the carrier 58. An outer diameter of the carrier 58 in a part other than the annular flange portion 58C is set smaller than an inner diameter of the opening portion 33A of the first housing 33. An outer diameter of the annular flange portion 58C is set larger than the inner diameter of the opening portion 33A of the first housing 33. A spline shaft portion 71 provided at a distal end of the columnar portion 70 of the rotary-to-linear ramp 65 of the ball-and-ramp mechanism 43 described later is fitted to the spline hole 58A of the carrier 58, and thus rotational torque may be transmitted between the carrier 58 and the rotary-to-linear ramp 65.

On the outer peripheral side of the carrier 58, a plurality of pin hole portions 58B are formed at predetermined intervals along the circumferential direction. The pins 60 are press-fitted to the pin hole portions 58B, respectively. The pins 60 are inserted through the hole portions 56B of the respective planet gears 56 in a freely rotatable and axially movable manner. Movement of the carrier 58 toward the disc rotor D is restricted by a wave washer 76 and a retaining ring 77, which are arranged in an annular groove portion 75 provided between the spline shaft portion 71 and the columnar portion 70. Note that, under a state in which a parking brake or the like is released, the carrier 58 has a predetermined length of a clearance 37 formed between the annular flange portion 58C of the carrier 58 and the wall portion 33B of the first housing 33 by the wave washer 76 and the retaining ring 77.

Further, in the first housing 33, a cover 61 is arranged so as to cover the outer periphery of the carrier 58. The cover 61 includes a cylindrical portion 61A for covering the outer periphery of the carrier 58, and an annular wall portion 61B connected to an end portion of the cylindrical portion 61A and provided between the carrier 58 and each planet gear 56. Further, axial movement of each planet gear 56 is restricted by the annular wall portion 61B of the cover 61 and an annular wall portion 57B of the internal gear 57. On the other hand, radial movement of the carrier 58 is restricted by the cylindrical wall portion 33C projecting from the wall portion 33B of the first housing 33. Further, axial movement of the carrier 58 is allowed in a region between the annular wall portion 61B of the cover 61 and the wall portion 33B of the first housing 33 by an amount corresponding to the length of the clearance 37 formed between the annular flange portion 58C of the carrier 58 and the wall portion 33B of the first housing 33.

The internal gear 57 includes internal teeth 57A, which mesh with the gears 56A of the respective planet gears 56, and the annular wall portion 57B, which is provided on the second speed reduction gear 49 side integrally with and continuously from the internal teeth 57A and is configured to restrict the axial movement of each planet gear 56. The internal gear 57 is press-fitted into the first housing 33 so as to be immovable in the axial direction and the rotational direction.

Note that, in order to obtain a rotational force for propelling the piston 25, this embodiment employs the spur gear multistage speed reduction mechanism 40 and the planetary gear speed reduction mechanism 41 each serving as the speed reduction mechanism for increasing the rotational force of the motor 32, but the planetary gear speed reduction mechanism 41 may be employed alone. Alternatively, a cycloid speed reduction mechanism, a strain wave gearing speed reducer, or other speed reducers of known technologies may be employed in combination with the planetary gear speed reduction mechanism 41.

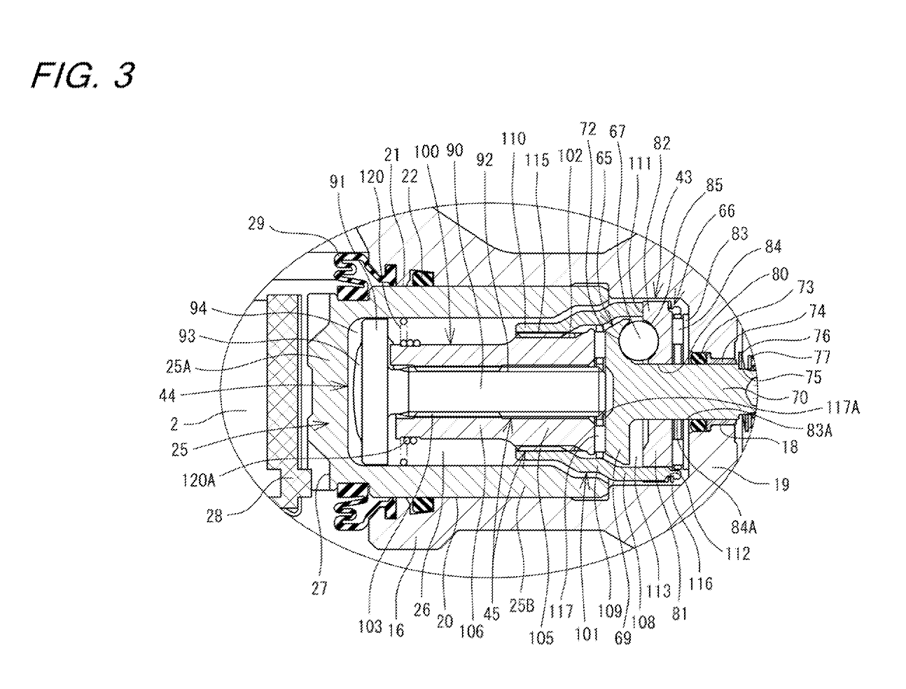

As illustrated in FIGS. 1 and 3, the ball-and-ramp mechanism 43 includes the rotary-to-linear ramp 65, a rotary ramp 66, and a plurality of balls 67 interposed between the rotary-to-linear ramp 65 and the rotary ramp 66.

The rotary-to-linear ramp 65 includes a disc-like rotary-to-linear plate 69, and the columnar portion 70 integrally extending from a substantially radial center of the rotary-to-linear plate 69. The rotary-to-linear ramp 65 is formed into a T-shape in cross section. The columnar portion 70 is inserted through each of an insertion hole 80 provided at a substantially radial center of a rotary plate 81 of the rotary ramp 66, a through hole 84A of a thrust bearing 84, a through hole 83A of a thrust washer 83, and the hole portion 18 provided in the bottom wall 19 of the cylinder 20. The spline shaft portion 71 fitted to the spline hole 58A provided in the carrier 58 is integrally formed at the distal end of the columnar portion 70. Further, in a surface of the rotary-to-linear plate 69 that is opposed to the rotary plate 81 of the rotary ramp 66, a plurality of (in this embodiment, three) ball grooves 72 are formed to extend in an arc shape along the circumferential direction at a predetermined inclination angle, and to have an arc-like cross section in the radial direction. Still further, an O-ring 73 and a sleeve 74 are arranged between the hole portion 18 of the bottom wall 19 of the cylinder 20 and an outer peripheral surface of the columnar portion 70 of the rotary-to-linear ramp 65. With the O-ring 73 and the sleeve 74, the fluid tightness of the hydraulic chamber 26 is maintained. The annular groove portion 75 is formed between the columnar portion 70 and the spline shaft portion 71 of the rotary-to-linear ramp 65. The wave washer 76 and the retaining ring 77 are mounted in the annular groove portion 75. With the wave washer 76 and the retaining ring 77, axial movement of the rotary-to-linear ramp 65, the carrier 58, and the pins 60 toward the inner and outer brake pads 2 and 3 due to the actuation of the parking brake is allowed within a predetermined range (corresponding to the axial length of the clearance 37).

The rotary ramp 66 is constructed as the rotary plate 81 having the insertion hole 80 provided at the substantially radial center thereof. On an outer peripheral portion of the rotary plate 81, a plurality of fitting projections 82 are provided at predetermined intervals in the circumferential direction. A wave clip 116 described later is placed on fitting stepped surfaces that are depressed from top surfaces of the respective fitting projections 82. Note that, an outer diameter of the rotary plate 81 excluding the fitting projections 82 is substantially equal to an outer diameter of the rotary-to-linear plate 69 of the rotary-to-linear ramp 65. The rotary plate 81 is supported in a freely rotatable manner onto the bottom wall 19 of the cylinder 20 through an intermediation of the thrust washer 83 and the thrust bearing 84. In a surface of the rotary plate 81 that is opposed to the rotary-to-linear plate 69 of the rotary-to-linear ramp 65, a plurality of (in this embodiment, three) ball grooves 85 are formed to extend in an arc shape along the circumferential direction at a predetermined inclination angle, and to have an arc-like cross section in the radial direction.

The balls 67 are interposed between the ball grooves 72 of the rotary-to-linear plate 69 of the rotary-to-linear ramp 65 and the ball grooves 85 of the rotary plate 81 of the rotary ramp 66, respectively. Further, in the ball-and-ramp mechanism 43, when rotational torque is applied to the rotary-to-linear ramp 65, the balls 67 roll between the ball grooves 72 of the rotary-to-linear plate 69 and the ball grooves 85 of the rotary plate 81, respectively, and thus a rotational difference is generated between the rotary-to-linear plate 69 and the rotary plate 81, that is, between the rotary-to-linear ramp 65 and the rotary ramp 66, to thereby fluctuate a relative axial distance between the rotary-to-linear plate 69 and the rotary plate 81.

The push rod 44 includes a shaft portion 90, and a disc-like flange portion 91 integrally connected to one end of the shaft portion 90 that is located closer to the inner and outer brake pads 2 and 3, and is therefore formed into a T-shape in cross section in the axial direction. An external thread portion 92, which threadedly engages with an internal thread portion 103 provided on an inner peripheral surface of an adjuster nut 100 described later, is formed in a region from a substantially axial center to a distal end of the shaft portion 90. The distal end of the shaft portion 90 is opposed to the substantially radial center of the rotary-to-linear ramp 65 (rotary-to-linear plate 69) of the ball-and-ramp mechanism 43 while passing through a through hole 117A of a thrust bearing 117. Further, the flange portion 91 of the push rod 44 has an outer peripheral shape substantially conforming to an inner peripheral shape of the piston 25, and is arranged to be opposed to the bottom portion 25A of the piston 25. Due to an engagement relationship between an outer peripheral surface of the flange portion 91 and an inner peripheral surface of the cylindrical portion 25B of the piston 25, the push rod 44 is movable in the axial direction relative to the piston 25, but the movement in the rotational direction is restricted. Further, a spherical projection 93 projecting toward the bottom portion 25A of the piston 25 is formed at a substantially radial center of the flange portion 91 of the push rod 44. When the push rod 44 advances, the spherical projection 93 of the flange portion 91 abuts against the bottom portion 25A of the piston 25. Note that, a plurality of groove portions (not shown) extending in the axial direction are formed in an outer peripheral portion of the flange portion 91 of the push rod 44. Through the groove portions, a space 94 surrounded by the bottom portion 25A of the piston 25 and the flange portion 91 of the push rod 44 communicates to the hydraulic chamber 26, with the result that a brake fluid may circulate therebetween and therefore air bleeding performance of the space 94 is secured.

The screw mechanism 45 is constructed as the thrust retaining mechanism for retaining the piston 25 at the braking position. The screw mechanism 45 includes a threaded engagement portion between an external thread portion 102 of the adjuster nut 100 and an internal thread portion 115 of a base nut 101, and a threaded engagement portion between the internal thread portion 103 of the adjuster nut 100 and the external thread portion 92 of the push rod 44.

The adjuster nut 100 is formed into a cylindrical shape, and includes a large-diameter cylindrical portion 105 having the external thread portion 102 provided on an outer peripheral surface thereof, and a small-diameter cylindrical portion 106 extending continuously from an end portion of the large-diameter cylindrical portion 105 toward the inner and outer brake pads 2 and 3. The adjuster nut 100 is substantially equal in length to the shaft portion 90 of the push rod 44. On the adjuster nut 100, the internal thread portion 103, which threadedly engages with the external thread portion 92 of the push rod 44, is formed over the entire axial range of the inner peripheral surface of the adjuster nut 100. The external thread portion 102, which threadedly engages with the internal thread portion 115 provided on an inner peripheral surface of a small-diameter cylindrical portion 110 of the base nut 101 described later, is formed on an outer peripheral surface of the large-diameter cylindrical portion 105 of the adjuster nut 100. An end portion of the large-diameter cylindrical portion 105 of the adjuster nut 100 on the ball-and-ramp mechanism 43 side is arranged to be opposed to the rotary-to-linear ramp 65 along the axial direction through an intermediation of the thrust bearing 117. In order to prevent the adjuster nut 100 from rotating in a retreating direction due to an axial load applied from the piston 25 to the rotary-to-linear ramp 65, the threaded engagement portion between the external thread portion 92 of the push rod 44 and the internal thread portion 103 of the adjuster nut 100 is set as a screw having a backward efficiency of 0 or less, that is, having a high irreversibility.

The base nut 101 is formed into a cylindrical shape, and includes a large-diameter cylindrical portion 108, a multistep cylindrical portion 109 extending continuously from an end portion of the large-diameter cylindrical portion 108 toward the inner and outer brake pads 2 and 3 so that a diameter thereof is reduced in a stepwise manner, and the small-diameter cylindrical portion 110 extending continuously from an end portion of the multistep cylindrical portion 109 toward the inner and outer brake pads 2 and 3. An outer diameter of the large-diameter cylindrical portion 108 is substantially equal to the outer diameter of the rotary plate 81 of the rotary ramp 66 (outer diameter of a part including the fitting projections 82). At an end portion of a peripheral wall portion of the large-diameter cylindrical portion 108, a plurality of fitting depressions 111 are formed at predetermined intervals in the circumferential direction. The fitting depressions 111 are opened on one side in the axial direction, and the fitting projections 82 provided on the rotary plate 81 of the rotary ramp 66 are fitted to the fitting depressions 111, respectively. In an outer peripheral surface of the large-diameter cylindrical portion 108 other than the fitting depressions 111, loosely-fitting groove portions 112 are formed so as to loosely fit the wave clip 116 described later therein along the circumferential direction. Further, a plurality of communication holes (not shown) are formed in a peripheral wall portion of the multistep cylindrical portion 109. Through the communication holes, a space 113 inside the base nut 101 communicates to the hydraulic chamber 26. As a result, the brake fluid may circulate between the space 113 and the hydraulic chamber 26, and air bleeding performance of the space 113 may be secured. Further, the internal thread portion 115, which threadedly engages with the external thread portion 102 provided on the outer peripheral surface of the adjuster nut 100, is formed on the inner peripheral surface of the small-diameter cylindrical portion 110. Note that, in order to prevent the base nut 101 from rotating in the retreating direction due to an axial load applied from the piston 25 to the base nut 101, the threaded engagement portion between the external thread portion 102 of the adjuster nut 100 and the internal thread portion 115 of the base nut 101 is set as a screw having a backward efficiency of 0 or less, that is, having a high irreversibility.

The wave clip 116 is configured to couple the base nut 101 to the rotary plate 81 of the rotary ramp 66, and extends in the circumferential direction to have a shape of a flat, thin, wavy plate. Note that, due to a biasing force of the wave clip 116, the base nut 101 is constantly biased in a direction toward the bottom wall 19 of the cylinder 20.

Further, as illustrated in FIGS. 1 and 3, a coil portion 120A of a coil spring clutch 120 serving as a one-way clutch member is wound around an outer periphery of an end portion of the small-diameter cylindrical portion 106 of the adjuster nut 100 that is located closer to the inner and outer brake pads 2 and 3. Similarly to the push rod 44, the coil spring clutch 120 is movable in the axial direction relative to the piston 25, but the movement in the rotational direction is restricted. The coil spring clutch 120 applies rotational torque when the adjuster nut 100 is to rotate in one direction, but does not substantially apply the rotational torque when the adjuster nut 100 is to rotate in another direction. In this embodiment, the coil spring clutch 120 applies rotational resistance torque against a rotational direction of the adjuster nut 100 for movement toward the ball-and-ramp mechanism 43. Note that, the magnitude of the rotational resistance torque of the coil spring clutch 120 is larger than that of rotational resistance torque of the threaded engagement portion between the external thread portion 102 of the adjuster nut 100 and the internal thread portion 115 of the base nut 101, which is generated due to the biasing force of the wave clip 116 when the adjuster nut 100 moves in the retreating direction relative to the base nut 101.

The rotary plate 81 of the rotary ramp 66 is then inserted into the large-diameter cylindrical portion 108 of the base nut 101, and the fitting projections 82 of the rotary plate 81 are fitted to the fitting depressions 111 of the base nut 101, respectively. After that, the wave clip 116 is interposed between each fitting stepped surface of the fitting projection 82 of the rotary plate 81 and one of the opposed surfaces of each loosely-fitting groove portion 112 of the base nut 101. As described above, due to the biasing force of the wave clip 116, the base nut 101 is biased in the direction toward the bottom wall 19 of the cylinder 20. As a result, the base nut 101 is non-rotatable relative to the rotary plate 81 of the rotary ramp 66, but is movable in the axial direction toward the disc rotor D until the wave clip 116 is squeezed between each fitting stepped surface of the fitting projection 82 of the rotary plate 81 and each loosely-fitting groove portion 112 of the base nut 101. Note that, the wave clip 116 is mounted so as to be non-rotatable relative to the base nut 101 (rotary plate 81).

Further, the balls 67 are interposed between the ball grooves 72 of the rotary-to-linear plate 69 and the ball grooves 85 of the rotary plate 81, and the columnar portion 70 of the rotary-to-linear ramp 65 is inserted through each of the insertion hole 80 of the rotary plate 81 of the rotary ramp 66, the through hole 84A of the thrust bearing 84, the through hole 83A of the thrust washer 83, and the hole portion 18 of the bottom wall 19 of the cylinder 20. Subsequently, the columnar portion 70 of the rotary-to-linear ramp 65 is inserted through the wave washer 76, and the spline shaft portion 71 thereof is spline-coupled to the spline hole 58A of the carrier 58. After that, the retaining ring 77 is mounted between the wave washer 76 and the carrier 58. Thus, the rotational torque is transmitted from the carrier 58 to the rotary-to-linear ramp 65, and the axial movement of the rotary-to-linear ramp 65, the carrier 58, and the pins 60 toward the inner and outer brake pads 2 and 3 is allowed within the predetermined range. Further, the rotary plate 81 of the rotary ramp 66 is supported in a freely rotatable manner onto the bottom wall 19 of the cylinder 20 through an intermediation of the thrust bearing 84. The adjuster nut 100 is supported in a freely rotatable manner onto the rotary-to-linear plate 69 of the rotary-to-linear ramp 65 through an intermediation of the thrust bearing 117. In addition, the external thread portion 102 provided on the outer peripheral surface of the adjuster nut 100 threadedly engages with the internal thread portion 115 provided on the inner peripheral surface of the small-diameter cylindrical portion 110 of the base nut 101. Further, the internal thread portion 103 provided on the inner peripheral surface of the adjuster nut 100 threadedly engages with the external thread portion 92 provided on the outer peripheral surface of the shaft portion 90 of the push rod 44.

As illustrated in FIGS. 1, 2, and 4, an ECU 121 constructed of an electronic control device serving as control means for controlling the drive of the motor 32 is connected to the motor 32. A parking switch 122 to be operated for instructions to actuate and release the parking brake is connected to the ECU 121. The motor 32 is juxtaposed to the caliper body 15 and received in the second housing 34. The rotation shaft 32A of the motor 32 extends toward the cover 36. Note that, two motor terminals 32C extend from a body portion 32B of the motor 32 in the same direction as the extending direction of the rotation shaft 32A. The motor terminals 32C are arranged on both sides of the rotation shaft 32A in the radial direction and connected to the ECU 121 through a connection member (not shown).

Further, the bearing member 10 is arranged inside the second housing 34 at a position between the first speed reduction gear 47 and the non-speed reduction spur gear 48 of the spur gear multistage speed reduction mechanism 40 and the body portion 32B of the motor 32. The bearing member 10 includes a plate-like portion 138 and a partially-cutout cylindrical portion 139. The plate-like portion 138 has an insertion hole 140 formed therein, for inserting therethrough the pinion gear 46 to which the rotation shaft 32A of the motor 32 is press-fitted. The partially-cutout cylindrical portion 139 having a partially-opened peripheral wall projects from a portion around the insertion hole 140 of the plate-like portion 138 toward the cover 36. The partially-cutout cylindrical portion 139 is arranged around the pinion gear 46. At the portion at which the peripheral wall of the partially-cutout cylindrical portion 139 is opened, the wheel 47A of the first speed reduction gear 47 meshes with the pinion gear 46.

A circular projecting portion 141 projects from the plate-like portion 138 of the bearing member 10 toward the motor 32. A support depression 141A is formed in the projecting portion 141. The shaft 52 for rotatably supporting the first speed reduction gear 47 is supported in the support depression 141A. A plurality of ribs 142 are formed around the partially-cutout cylindrical portion 139. A disc-like bearing portion 143 is formed on a distal end surface of the partially-cutout cylindrical portion 139. A hole portion 143A is formed at a substantially radial center of the bearing portion 143. The shaft 53 for rotatably supporting the non-speed reduction spur gear 48 is supported in the hole portion 143A. Through holes 145 and 145 are formed at positions on both sides of the insertion hole 140 of the plate-like portion 138 in the radial direction. The motor terminals 32C extending from the body portion 32B of the motor 32 are inserted through the through holes 145, respectively. On an outer peripheral portion of the plate-like portion 138, a plurality of fixing portions 146 for fixing the bearing member 10 to the motor 32 are formed (in this embodiment, at two positions). The fixing portions 146 project from the plate-like portion 138 toward the motor 32. Portions of the plate-like portion 138 at the positions of the fixing portions 146 are depressed from the cover 36 side, and in the bottom portions thereof, there are formed insertion holes 148 for inserting therethrough mounting bolts 147 for fixing the bearing member 10 to the motor 32. The insertion hole 140 for inserting the pinion gear 46 therethrough and the through holes 145 and 145 for inserting the motor terminals 32C therethrough are positioned between the insertion holes 148.

Next, actions of the disc brake 1 according to this embodiment are described. First, actions of the disc brake 1 serving as a general hydraulic brake through operations of a brake pedal are described.

When a driver depresses the brake pedal, a hydraulic pressure in accordance with a pedaling force of the brake pedal is supplied from the master cylinder (not shown) to the hydraulic chamber 26 inside the caliper 4 through a hydraulic circuit (not shown). Thus, the piston 25 advances from its original position in a non-braking state (moves in the leftward direction in FIG. 1) while elastically deforming the piston seal 22, to thereby press the inner brake pad 2 against the disc rotor D. Then, the caliper body 15 moves in the rightward direction in FIG. 1 relative to the bracket 5 due to a reaction force against the pressing force of the piston 25, to thereby press the outer brake pad 3 against the disc rotor D with the claw portion 17. As a result, the disc rotor D is squeezed between the pair of the inner and outer brake pads 2 and 3 so that a frictional force is generated, and a braking force for the vehicle is therefore generated.

When the driver releases the brake pedal, on the other hand, the supply of the hydraulic pressure from the master cylinder is interrupted so that the hydraulic pressure inside the hydraulic chamber 26 is decreased. Thus, the piston 25 retreats to the original position due to a restoring force generated through the elastic deformation of the piston seal 22. As a result, the braking force is released.

Next, actions of the disc brake 1 according to this embodiment serving as, for example, a parking brake are described. First, the parking switch 122 is operated under a state in which the parking brake is released, and an electric signal is input from the ECU 121 to the motor 32 so that the motor 32 is driven. Through the drive of the motor 32, the sun gear 49B of the planetary gear speed reduction mechanism 41 rotates through an intermediation of the spur gear multistage speed reduction mechanism 40. Through the rotation of the sun gear 49B, the carrier 58 rotates through an intermediation of the planet gears 56. Then, the rotational force is transmitted from the carrier 58 to the rotary-to-linear ramp 65. At an initial stage of transmission of the rotational force from the carrier 58 to the rotary-to-linear ramp 65, the rotary-to-linear ramp 65, the rotary ramp 66, the base nut 101, and the adjuster nut 100 integrally rotate due to the rotational force from the carrier 58. Then, through the rotation of the adjuster nut 100, the screw mechanism 45, that is, the threaded engagement portion between the internal thread portion 103 of the adjuster nut 100 and the external thread portion 92 of the push rod 44 relatively rotates so that the push rod 44 advances (moves in the leftward direction in FIG. 1). Thus, the spherical projection 93 of the flange portion 91 of the push rod 44 abuts against the bottom portion 25A of the piston 25 so that the piston 25 advances.

When the motor 32 is further driven, through the movement of the push rod 44, the piston 25 starts to press the disc rotor D through an intermediation of the brake pads 2 and 3. When this pressing force starts to be generated, the rotation of the adjuster nut 100 is stopped. Then, the rotary-to-linear ramp 65 advances while rotating, and the rotary ramp 66 rotates while generating a rotational difference from the rotary-to-linear ramp 65. As a result, the internal thread portion 115 of the base nut 101 and the external thread portion 102 of the adjuster nut 100 move relative to each other so that the adjuster nut 100 advances in the axial direction.

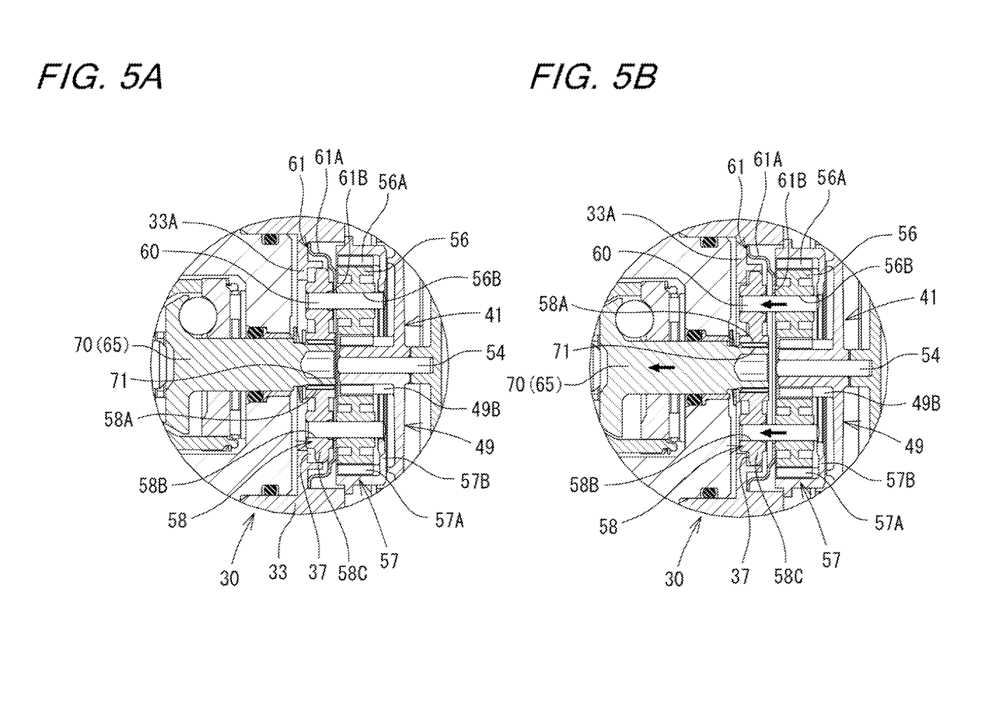

In this case, a pitch diameter of the pins 60 that support the respective planet gears 56 is larger than an effective diameter of the spline hole 58 of the carrier 58, and hence an axial load generated through the torque transmission is smaller in the fitting portion between the pins 60 and the hole portions 56B of the planet gears 56 than in the spline-coupling portion between the spline hole 58A of the carrier 58 and the spline shaft portion 71 of the rotary-to-linear ramp 65. As a result, when the rotary-to-linear ramp 65 advances, as illustrated in FIG. 5B, the carrier 58 including the respective pins 60 advances together with the rotary-to-linear ramp 65 so as to move away from the annular wall portion 61B of the cover 61, to thereby enter the opening portion 33A of the first housing 33. At his time, the relative axial movement between the carrier 58 and the rotary-to-linear ramp 65 does not substantially occur. Further, a plurality of (in this embodiment, four) pins 60 are provided, and the axial load to be received by a single pin 60 is further reduced. Therefore, the load applied to the fitting portion between the pins 60 and the hole portions 56B of the planet gears 56 may further be reduced, with the result that the durability may be enhanced. Then, the adjuster nut 100 advances in the axial direction, and accordingly the piston 25 advances through an intermediation of the push rod 44. As a result, the pressing force of the piston 25 that is applied to the disc rotor D is increased.

Then, the ECU 121 drives the motor 32 until the pressing force applied from the pair of the inner and outer brake pads 2 and 3 to the disc rotor D reaches a predetermined value. After that, when it is detected that the pressing force applied to the disc rotor D reaches the predetermined value based on the detection that the current value of the motor 32 reaches a predetermined value, the ECU 121 stops energizing the motor 32. In this case, the reaction force against the pressing force for the disc rotor D is applied to the rotary ramp 66 through an intermediation of the piston 25 and the rotary-to-linear ramp 65. However, the adjuster nut 100 threadedly engages with the push rod 44 at the internal thread portion 103 and the external thread portion 92 that are not actuated in the reverse direction, and the base nut 101 also threadedly engages with the adjuster nut 100 at the internal thread portion 115 and the external thread portion 102 that are not actuated in the reverse direction. Therefore, the rotary ramp 66 does not rotate and remains in the stopped state so that the piston 25 is retained at the braking position. Thus, the braking force is retained and the actuation of the parking brake is completed.

When the parking brake is released subsequently, based on a parking brake releasing operation of the parking switch 122, the ECU 121 returns the piston 25, that is, drives the motor 32 in a rotational direction of moving the piston 25 away from the disc rotor D. Thus, the spur gear multistage speed reduction mechanism 40 and the planetary gear speed reduction mechanism 41 rotate in a direction of returning the piston 25, and the push rod 44 finally retreats in a direction of moving away from the piston 25. In this manner, the parking brake is released.

At that time, as illustrated in FIG. 5A, the rotary-to-linear ramp 65 retreats, and at the same time, the carrier 58 and the respective pins 60 retreat in a similar manner. The carrier 58 abuts against the annular wall portion 61B of the cover 61 with the wave washer 76 and the retaining ring 77, and therefore returns to the initial state, in which the predetermined length of the clearance 37 is formed between the annular flange portion 58C of the carrier 58 and the wall portion 33B of the first housing 33. Thus, when the parking brake is actuated, the carrier 58 including the respective pins 60 may reliably advance in the axial direction together with the rotary-to-linear ramp 65. Note that, when the carrier 58 is positioned on the wall portion 33B side of the first housing 33 under the state in which the parking brake is released, the carrier 58 cannot advance even if the rotary-to-linear ramp 65 advances, and the spline shaft portion 71 slides between the spline shaft portion 71 of the rotary-to-linear ramp 65 and the spline hole 58A of the carrier 58. As a result, there is a fear in that the actuation efficiency becomes poor and the durability of this portion decreases.

As described above, in the disc brake 1 according to this embodiment, the pins 60 press-fitted to the pin hole portions 58B of the carrier 58 are inserted through the hole portions 56B of the respective planet gears 56 in a freely rotatable and axially movable manner. Further, the axial movement of the carrier 58 is allowed between the annular wall portion 61B of the cover 61 and the wall portion 33B of the first housing 33 by an amount corresponding to the length of the clearance 37. As a result, when the parking brake is actuated, the carrier 58 and the pins 60 advance together with the rotary-to-linear ramp 65 along with the advance of the rotary-to-linear ramp 65. Thus, as compared to the embodiment in which the spline shaft portion 71 of the rotary-to-linear ramp 65 slides in the axial direction relative to the spline hole 58A of the carrier 58 along with the advance of the rotary-to-linear ramp 65, the actuation efficiency becomes excellent and the durability is also enhanced in the embodiment of the present invention, in which the pins 60 of the carrier 58 slide through the hole portions 56B of the respective planet gears 56.

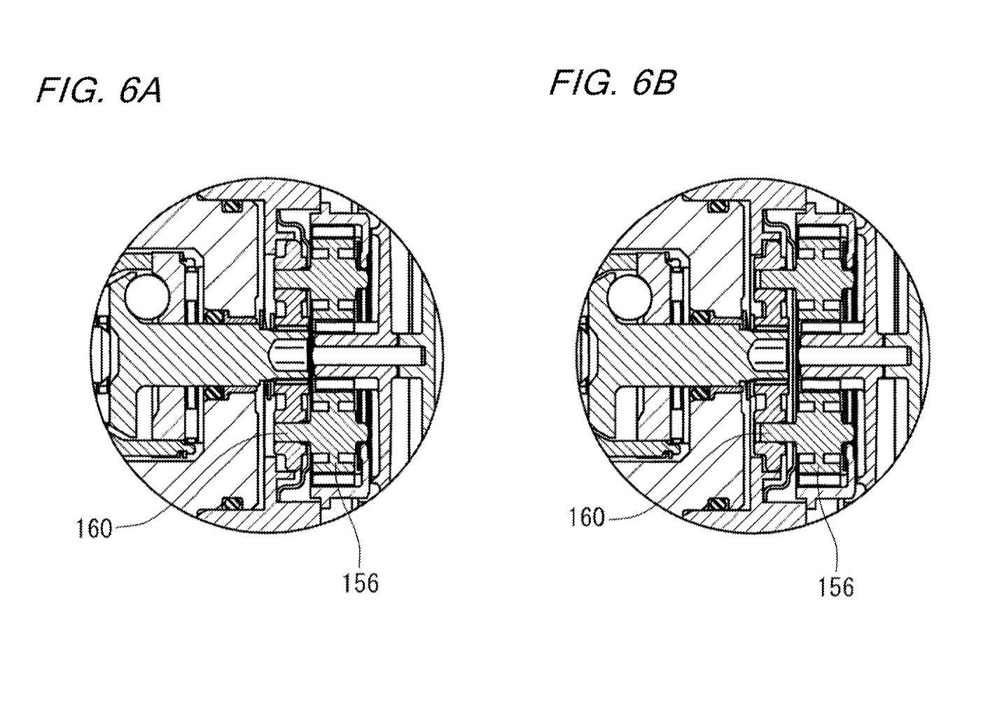

Further, in the disc brake 1 according to this embodiment, when the parking brake is released, the carrier 58 abuts against the annular wall portion 61B of the cover 61 with the wave washer 76 and the retaining ring 77, and is maintained in the state in which the clearance 37 is provided between the carrier 58 and the wall portion 33B of the first housing 33. Therefore, when the parking brake is actuated next time, the carrier 58 including the respective pins 60 may reliably advance in the axial direction together with the rotary-to-linear ramp 65. Note that, the embodiment described above is directed to the example in which the pins 60 mounted to the carrier 58 so as to be immovable at least in the axial direction are provided in the hole portions 56B of the respective planet gears 56 in an axially movable and rotatable manner, but the present invention is not limited thereto. As illustrated in FIGS. 6A and 6B, pins 160 (shaft portion) may be molded integrally with planet gears 156, respectively, and the pins 160 may be provided in the carrier 58 in an axially movable and rotatable manner. Note that, the other structure of FIGS. 6A and 6B is similar to the above-mentioned structure illustrated in FIGS. 5A and 5B. As described above, according to the present invention, other structures may be employed as long as the meshing gears are not shifted relatively in the axial direction and the shafts of the gears are provided in an axially movable and rotatable manner.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2012-216273, filed on Sep. 28, 2012. The entire disclosure of Japanese Patent Applications No. 2012-216273, filed on Sep. 28, 2012 including specification, claims, drawings and summary is incorporated herein by reference in its entirety.

What is claimed is:

1. A disc brake, comprising:
a pair of pads arranged across a rotor at positions on both sides in an axial direction of the rotor;
a piston for pressing one of the pair of pads;
a caliper body comprising a cylinder into which the piston is received in a movable manner;
an electric motor provided to the caliper body;
a speed reduction mechanism for increasing and transmitting a rotational force of the electric motor by a plurality of rotational members; and
a piston propelling mechanism linearly movable due to the rotational force transmitted from the speed reduction mechanism so as to propel the piston to a braking position,
wherein the piston propelling mechanism comprises a portion coupled to the speed reduction mechanism, which is linearly movable in an axial direction of the cylinder relative to a portion of the speed reduction mechanism that receives the rotational force input from the electric motor,
wherein the speed reduction mechanism comprises a shaft member for axially supporting at least one of a plurality of gears meshing with each other, and
wherein one of the shaft member and a bearing portion for supporting the shaft member is provided so as to be freely rotatable and axially movable relative to the at least one of the plurality of gears, and is provided integrally with the portion coupled to the speed reduction mechanism.

2. A disc brake according to claim 1, further comprising a restriction member for restricting axial movement of the one of the shaft member and the bearing portion relative to the at least one of the plurality of gears.

3. A disc brake according to claim 1, further comprising means for biasing the portion coupled to the speed reduction mechanism in a direction toward the portion that receives the rotational force input from the electric motor.

4. A disc brake according to claim 1, wherein the speed reduction mechanism comprises a planetary gear mechanism comprising:
a sun gear serving as a portion for transmitting the rotational force from the electric motor;
a plurality of planet gears meshing with the sun gear;
an internal gear meshing with each of the plurality of planet gears; and
a carrier comprising a portion for coupling, to the piston propelling mechanism, the one of the shaft member for axially supporting the each of the plurality of planet gears and the bearing portion.

5. A disc brake according to claim 4,
wherein the shaft member is fixed to the carrier and inserted through a hole portion formed in the each of the plurality of planet gears, and
wherein, when the carrier is linearly moved by the piston propelling mechanism, the shaft member slides in the hole portion.

6. A disc brake according to claim 4,
wherein the shaft member is provided integrally with the each of the plurality of planet gears and inserted through the bearing portion formed in the carrier, and
wherein, when the carrier is linearly moved by the piston propelling mechanism, the shaft member slides in the bearing portion.

7. A disc brake according to claim 4,
wherein the bearing portion comprises a plurality of holes formed in the carrier,
wherein the shaft member of the each of the plurality of planet gears is inserted through each of the plurality of holes, and
wherein, when the carrier is linearly moved by the piston propelling mechanism, the shaft member slides in the each of the plurality of holes.

8. A disc brake, comprising:
a piston for pressing a pad against a disc rotor;
a caliper body comprising a cylinder into which the piston is received in a movable manner;
an electric motor provided to the caliper body;
a speed reduction mechanism for increasing and transmitting a rotational force of the electric motor by a plurality of rotational members; and
a piston propelling mechanism linearly movable due to the rotational force transmitted from the speed reduction mechanism so as to propel the piston to a braking position,
wherein the piston propelling mechanism comprises a portion coupled to the speed reduction mechanism, which is linearly movable in an axial direction of the cylinder relative to a portion of the speed reduction mechanism that receives the rotational force input from the electric motor,
wherein the speed reduction mechanism comprises a shaft member for axially supporting at least one of a plurality of gears meshing with each other, and
wherein the shaft member is provided so as to be freely rotatable and axially movable relative to the at least one of the plurality of gears, and is provided so as to be linearly movable together with the portion coupled to the speed reduction mechanism.

9. A disc brake according to claim 8, further comprising a restriction member for restricting axial movement of the shaft member relative to the at least one of the plurality of gears.

10. A disc brake according to claim 8, further comprising means for biasing the portion coupled to the speed reduction mechanism in a direction toward the portion that receives the rotational force input from the electric motor.

11. A disc brake according to claim 8, wherein the speed reduction mechanism comprises a planetary gear mechanism comprising:
a sun gear serving as a portion for transmitting the rotational force from the electric motor;
a plurality of planet gears meshing with the sun gear;
an internal gear meshing with each of the plurality of planet gears; and
a carrier comprising a portion for coupling, to the piston propelling mechanism, the shaft member for axially supporting the each of the plurality of planet gears.

12. A disc brake, comprising:
a caliper body having a piston which is received in the caliper body in a movable manner, the piston being configured to press a pad against a disc rotor;
a speed reduction mechanism for increasing and transmitting a rotational force of an electric motor by a plurality of rotational members, the electric motor being provided to the caliper body; and
a piston propelling mechanism linearly movable due to the rotational force transmitted from the speed reduction mechanism so as to propel the piston to a braking position,
wherein the piston propelling mechanism comprises a portion coupled to the speed reduction mechanism, which is linearly movable in a moving direction of the piston relative to a portion of the speed reduction mechanism that receives the rotational force input from the electric motor,
wherein the speed reduction mechanism comprises:
a sun gear serving as a portion for transmitting the rotational force from the electric motor;
a plurality of planet gears meshing with the sun gear;
an internal gear meshing with each of the plurality of planet gears; and
a carrier for axially supporting the each of the plurality of planet gears, the carrier comprising a portion coupled to the piston propelling mechanism, and
wherein the carrier further comprises a shaft member for axially supporting the each of the plurality of planet gears in a freely rotatable and axially movable manner.

13. A disc brake according to claim 12, further comprising a restriction member for restricting axial movement of the shaft member relative to the each of the plurality of planet gears.

14. A disc brake according to claim 12, further comprising means for biasing the portion coupled to the speed reduction mechanism in a direction toward the portion that receives the rotational force input from the electric motor.
